(19) United States
(12) Patent Application Publication
(10) Pub. No.: US 2023/0276813 A1
(43) Pub. Date: Sep. 7, 2023

(54) METHOD OF PREPARING AN AERATED BATTER, THE BATTER, A CAKE, USE OF PROTEIN IN AERATED BATTER, A POWDER COMPOSITION AND METHOD OF PREPARATION

(71) Applicant: Arla Foods Amba, Viby J (DK)

(72) Inventors: Rikke Eleonore NYTOFT, Viby J (DK); Inge Lise POVLSEN, Viby J (DK)

(21) Appl. No.: 18/009,000

(22) PCT Filed: Jun. 11, 2021
(86) PCT No.: PCT/EP2021/065806

§ 371 Date: Dec. 8, 2022

(30) Foreign Application Priority Data
Jun. 12, 2020 (EP) 20179699.2

(51) Int. Cl. A21D 10/00; A21D 2/26

(52) U.S. Cl. CPC A21D 10/005; A21D 2/263

(57) ABSTRACT

The present invention relates to a method of preparing an aerated batter, the aerated batter prepared by the method, a cake obtainable by baking the aerated batter, the use of a protein source comprising beta-lactoglobulin in an aerated batter, a powder composition comprising the protein source comprising BLG and a method of producing the powder composition.

### FIELD OF THE INVENTION

The present invention relates to a method of preparing an aerated batter, the aerated batter obtainable by the method, a cake obtainable by baking the aerated batter, the use of a protein source comprising beta-lactoglobulin (BLG) in an aerated batter, a powder composition comprising the protein source comprising BLG and a method of producing the powder composition.

### BACKGROUND

Many cakes are traditionally made with eggs, e.g. in the form of whole eggs or egg whites. Eggs are particularly interesting for cakes made from aerated batters as eggs tend to stabilize the aerated batter prior to and during baking which results in an attractive light and soft crumb of the cake.

It has previously been suggested to use modified whey protein isolates for egg white replacement in baked products.

US 2002/0061359 discloses a modified whey protein isolate having the ability to fully replace egg whites in many food applications that require foaming, including some cakes, prepared by a process which involves heat treating to obtain a unique balance of overrun and foam stability properties. The process entails heating an aqueous solution of whey protein isolate at from 70 to 85° C., and can include holding at this temperature and pH adjustment prior to heating to obtain the desired properties. Food mixes employing the modified whey protein isolate and processes for making food products employing the modified whey protein isolate are also provided.

JP 2007143485 A discloses a baked Japanese style or Western style confectionery especially without using eggs, such as sponge cake, chiffon cake, and cheese cake, suppressed in volume decrease, and having moist soft palate feeling and springiness. The baked confectionery contains whey protein having ≥60 wt. % of beta-lactoglobulin in the total protein at dry matter conversion.

EP 1 450 614 A1 discloses a method for preparing fat-containing cake batter, in particular for preparing pound cake batter which is used to prepare what are known as pound cakes, at least some of the eggs being replaced by caseinate. EP 1 450 614 A1 also discloses an emulsion for preparing the batter, to which only one or more dry ingredients have to be added in order to obtain the batter, which can be beaten in one step, and to a method for preparing cake using the abovementioned cake batter, and to a baked product obtained by baking the cake batter for the usual time and at the usual temperature.

### SUMMARY OF THE INVENTION

The present inventors have found that protein sources containing beta-lactoglobulin (BLG) in high purity relative to total protein make it is possible to reduce or even replace whole egg or egg whites in the production of aerated batters.

Thus, an aspect of the invention pertains to a method of preparing an aerated batter, the method comprising:
a. Providing a protein source comprising BLG, wherein BLG constitutes at least 85% of the protein of the protein source comprising BLG,
b. Providing one or more batter ingredients comprising at least one of: sugar, flour, and starch,
c. Mixing the one or more batter ingredients with the protein source comprising BLG to form a mixture, and
the method furthermore comprises at least one aeration step, thereby providing the aerated batter.

The at least one aeration step preferably involves aerating one or more of:
the protein source comprising BLG,
the one or more batter ingredients,
a premixture made during step c. comprising the protein source comprising BLG and/or the one or more batter ingredients, and
the mixture.

The aerated batter will therefore be the mixture as such if all aeration step(s) take place prior to or during step c. or the product obtained from aeration of the mixture if the mixture obtained from step c. is subjected to further aeration.

Another aspect of the invention pertains to an aerated batter obtainable by the above method.

Yet an aspect of the invention pertains to a process for producing a cake which process comprises the steps of the above-mentioned method and furthermore comprises a step of baking the aerated batter. Another aspect pertains to a cake obtainable by a process of producing a cake including baking the aerated batter.

A further aspect of the invention pertains to the use of a protein source comprising BLG as defined herein in an aerated batter, wherein the BLG constitutes at least 85% of the protein of the protein source comprising BLG. The use is preferably for partially or fully replacing whole egg or alternatively, for partially or fully replacing egg white.

Yet an aspect of the invention pertains to a powder composition suitable for making an aerated batter, which powder composition comprises one or more batter ingredients and a protein source comprising BLG, wherein the BLG constitutes at least 85% of the protein of the protein source comprising BLG, and where the one or more batter ingredients are dry and comprise at least one of whole egg, egg white, sugar, flour and starch.

An even further aspect of the invention pertains to a method of producing the above powder composition, the method comprising:
i) Providing one or more batter ingredients and a protein source comprising BLG, wherein the BLG constitutes at least 85% of the protein of the protein source comprising BLG,
ii) mixing the one or more batter ingredients and the protein source comprising BLG to form a, preferably uniform, powder composition, and
iii) optionally, packaging the powder composition, wherein the one or more batter ingredients comprises at least one of sugar, flour and starch.

### BRIEF DESCRIPTION OF THE FIGURES

FIG. 1 shows the density of different variants of aerated batter produced in Example 2.

FIG. 2 shows the volume of different variants of cakes prepared in Example 2.

FIG. 3 shows the hardness of different variants of cakes prepared in Example 2. FIG. 4 shows the springiness of different variants of cakes prepared in Example 2.

FIG. 5 shows the resilience of different variants of cakes prepared in Example 2.

FIG. 6 shows the density of different variants of aerated batter produced in Example 3.

FIG. 7 shows the volume of different variants of cakes prepared in Example 3.

FIG. 8 shows the hardness of different variants of cakes prepared in Example 3.

FIG. 9 shows the springiness of different variants of cakes prepared in Example 3.

FIG. 10 shows the resilience of different variants of cakes prepared in Example 3.

### DETAILED DESCRIPTION

An aspect of the invention pertains to a method of preparing an aerated batter, the method comprising:
a. Providing a protein source comprising BLG, wherein BLG constitutes at least 85% of the protein of the protein source comprising BLG,
b. Providing one or more batter ingredients comprising at least one of: sugar, flour, and starch,
c. Mixing the one or more batter ingredients with the protein source comprising BLG to form a mixture, and
the method furthermore comprises at least one aeration step, thereby providing the aerated batter.

The at least one aeration step preferably involves aerating one or more of:
the protein source comprising BLG,
the one or more batter ingredients,
a premixture made during step c. comprising the protein source comprising BLG and/or the one or more batter ingredients, and
the mixture.

In the context of the present invention, the term “aerated batter” means a batter in which air and/or gas has been incorporated. In some preferred embodiments of the invention, the amount of air or gas incorporated in the aerated batter is sufficient to decreases the density of the aerated batter with at least 5% relative to the non-aerated batter. The term “non-aerated batter” or “batter, which is not aerated” means a batter, which does not contain bubbles of air or gas. The term “aerating” or “aeration” means incorporation of air or gas.

In the context of the present invention, the term “protein source comprising BLG” refers to an edible protein source which comprises BLG in an amount of at least 85% w/w relative to total protein. The “protein source comprising BLG” may be a single protein source containing BLG or the combination of several protein sources comprising BLG that all have the high BLG purity described herein.

The protein source comprising BLG is preferably derived from mammal milk or whey. In some preferred embodiments of the invention, the protein source comprising BLG only contain proteins from mammal milk or whey. The protein source comprising BLG preferably only contains proteins from whey or milk serum. The protein source comprising BLG preferably originates from mammal milk, and more preferably from ruminant milk, such as e.g. milk from cow, sheep, goat, buffalo, camel, llama, mare and/or deer. Protein sources originating from bovine milk is particularly preferred. The BLG is therefore preferably bovine BLG.

In the context of the present invention, the term “beta-lactoglobulin” or “BLG” pertains to beta-lactoglobulin from mammal species, e.g. in native, unfolded and/or glycosylated forms and includes the naturally occurring genetic variants. The term furthermore includes aggregated BLG, precipitated BLG and crystalline BLG. When referring to the amount of BLG, reference is made to the total amount of BLG including aggregated BLG. The total amount of BLG is determined according to Example 1.8. The term “aggregated BLG” pertains to BLG which is at least partially unfolded and which furthermore has aggregated with other denatured BLG molecules and/or other denatured whey proteins, typically by means of hydrophobic interactions and/or covalent bonds.

BLG is the most predominant protein in bovine whey and milk serum and exists in several genetic variants, the main ones in cow milk being labelled A and B. BLG is a lipocalin protein, and can bind many hydrophobic molecules, suggesting a role in their transport. BLG has also been shown to be able to bind iron via siderophores and might have a role in combating pathogens. A homologue of BLG is lacking in human breast milk.

Bovine BLG is a relatively small protein of approx. 162 amino acid residues with a molecular weight of approx. 18.3-18.4 kDa. Under physiological conditions, it is predominantly dimeric, but dissociates to a monomer below about pH 3, preserving its native state as determined using Nuclear Magnetic Resonance spectroscopy. Conversely, BLG also occurs in tetrameric, octameric and other multimeric aggregation forms under a variety of natural conditions.

In the context of the present invention the term “whey” pertains to the liquid phase that is left after the casein of milk has been precipitated and removed. Casein precipitation may e.g. be accomplished by acidification of milk and/or by use of rennet enzyme. Several types of whey exist, such as “sweet whey”, which is the whey product produced by rennet-based precipitation of casein, and “acid whey” or “sour whey”, which is the whey product produced by acid-based precipitation of casein. Acid-based precipitation of casein may e.g. be accomplished by addition of food acids or by means of bacterial cultures.

In the context of the present invention the term “milk serum” pertains to the liquid which remains when casein and milk fat globules have been removed from milk, e.g. by microfiltration or large pore ultrafiltration. Milk serum may also be referred to as “ideal whey”.

In the context of the present invention the term “milk serum protein” or “serum protein” pertains to the protein which is present in the milk serum.

In the context of the present invention, the term “whey protein” pertains to protein that is found in whey or in milk serum. Whey protein may be a subset of the protein species found in whey or milk serum, and even a single whey protein species or it may be the complete set of protein species found in whey or/and in milk serum.

More details regarding both whey proteins and BLG can be found in WO 2020/002426.

The inventors have found that protein sources having a high content of BLG advantageously can be used for producing aerated batter and cakes baked from the aerated batter. In some preferred embodiments of the invention, BLG constitutes at least 90% w/w of the protein of the protein source comprising BLG, more preferably at least 95% w/w, and most preferably at least 96% w/w, such as preferably at least 97% w/w, or at least 98% w/w or at least 99% w/w of the protein of the protein source comprising BLG.

In some preferred embodiments, the invention pertains to a method of preparing an aerated batter, the method comprising:
a. Providing a protein source comprising BLG, wherein BLG constitutes at least 90% of the protein of the protein source comprising BLG, more preferably at least 95% w/w, and most preferably at least 96% w/w of the protein of the protein source comprising BLG,
b. Providing one or more batter ingredients comprising at least one of: sugar, flour, and starch,
c. Mixing the one or more batter ingredients with the protein source comprising BLG to form a mixture, and
the method furthermore comprises at least one aeration step, thereby providing the aerated batter.

In some preferred embodiments of the invention, the BLG provided by the protein source comprising BLG is in its native state and therefore has a low degree of protein denaturation. The protein source comprising BLG preferably has a degree of protein denaturation of at most 90%, more preferably at most 70%, even more preferably at most 50%, and most preferably at most 30%.

In some preferred embodiments of the invention, the protein source comprising BLG has a degree of protein denaturation of at most 10%, more preferably at most 8%, even more preferably at most 5%, and most preferably at most 2%.

In other preferred embodiments of the invention, the BLG provided with the protein source comprising BLG is primarily in a denatured state and therefore has a fairly high degree of protein denaturation. In such cases, the protein source comprising BLG may have has a degree of protein denaturation of at least 20%, more preferably at least 30%, even more preferably at least 50%, even more preferably at least 70%, and most preferably at least 90%. Even higher levels of denaturation are feasible and in some preferred embodiments of the invention the protein source comprising BLG has a degree of protein denaturation of at least 92%, more preferably at least 95%, even more preferably at least 96%, and more preferably at least 97, such as e.g. at least 98% or at least 99%.

In some preferred embodiments, the invention pertains to a method of preparing an aerated batter, the method comprising:
a. Providing a protein source comprising BLG, wherein BLG constitutes at least 85% of the protein of the protein source comprising BLG, and wherein the protein source comprising BLG has a degree of protein denaturation of at most 10%, more preferably at most 8%, even more preferably at most 5%, and most preferably at most 2%,
b. Providing one or more batter ingredients comprising at least one of: sugar, flour, and starch,
c. Mixing the one or more batter ingredients with the protein source comprising BLG to form a mixture, and
the method furthermore comprises at least one aeration step, thereby providing the aerated batter.

In other preferred embodiments, the invention pertains to a method of preparing an aerated batter, the method comprising:
a. Providing a protein source comprising BLG, wherein BLG constitutes at least 90% of the protein of the protein source comprising BLG, and wherein the protein source comprising BLG has a degree of protein denaturation of at most 10%, more preferably at most 8%, even more preferably at most 5%, and most preferably at most 2%,
b. Providing one or more batter ingredients comprising at least one of: sugar, flour, and starch,
c. Mixing the one or more batter ingredients with the protein source comprising BLG to form a mixture, and
the method furthermore comprises at least one aeration step, thereby providing the aerated batter.

In further preferred embodiments, the invention pertains to a method of preparing an aerated batter, the method comprising:
a. Providing a protein source comprising BLG, wherein BLG constitutes at least 95% of the protein of the protein source comprising BLG, and wherein the protein source comprising BLG has a degree of protein denaturation of at most 10%, more preferably at most 8%, even more preferably at most 5%, and most preferably at most 2%,
b. Providing one or more batter ingredients comprising at least one of: sugar, flour, and starch,
c. Mixing the one or more batter ingredients with the protein source comprising BLG to form a mixture, and
the method furthermore comprises at least one aeration step, thereby providing the aerated batter.

The inventors have observed that a low content of caseinomacropeptide (CMP) in the protein source comprising BLG improves characteristics of the baked cake. In some preferred embodiments, the protein source comprising BLG contains CMP in an amount of at most 10% w/w relative to total protein, more preferably at most 8% w/w relative to total protein, even more preferably at most 6% w/w relative to total protein, and most preferably at most 4% w/w relative to total protein. In some preferred embodiments of the invention, the protein source comprising BLG is substantially free of CMP.

In even more preferred embodiments of the invention, the protein source comprising BLG contains CMP in an amount of at most 3% w/w relative to total protein, more preferably at most 2% w/w relative to total protein, even more preferably at most 1% w/w relative to total protein, and most preferably at most 0.5% w/w relative to total protein.

In some preferred embodiments, the protein source comprising BLG contains fat in an amount of at most 5% w/w relative to total solids, more preferably at most 2% w/w relative to total solids, even more preferably at most 1% w/w relative to total solids, and most preferably at most 0.1% w/w relative to total solids. In some preferred embodiments of the invention, the protein source comprising BLG is substantially free of fat.

In some preferred embodiments, the protein source comprising BLG contains carbohydrate in an amount of at most 60% w/w relative to total solids, more preferably at most 40% w/w relative to total solids, even more preferably at most 20% w/w relative to total solids, and most preferably at most 10% w/w relative to total solids.

Even lower amounts of carbohydrate are often preferred and in some preferred embodiments, the protein source comprising BLG contains carbohydrate in an amount of at most 5% w/w relative to total solids, more preferably at most 2% w/w relative to total solids, even more preferably at most 0.5% w/w relative to total solids, and most preferably at most 0.1% w/w relative to total solids. In some preferred embodiments of the invention, the protein source comprising BLG is substantially free of carbohydrate.

The protein source comprising BLG may be provided as a liquid or a powder. In some preferred embodiments, the protein source comprising BLG is used in an aerated batter, e.g. according to the inventive method, wherein the protein source comprising BLG is provided as a liquid or as a powder.

In the context of the present invention, a powder contains at most 10% w/w water, preferably at most 7% w/w and most preferably at most 5% w/w.

The protein source comprising BLG may be provided in liquid form, typically as an aqueous solution or dispersion. An aqueous solution of the protein source comprising BLG can be obtained by dissolving BLG in water, e.g. by mixing BLG in powder form and water while stirring and optionally leave the solution standing for a short period of time.

In some preferred embodiments of the invention, the protein source comprising BLG is a WPI or a WPC, wherein BLG constitutes at least 85% w/w of the protein source. A WPC has a total protein content in the range of 30-84% w/w relative to total solids and a WPI has a protein content of at least 85% w/w relative to total solids. The WPC or WPI are preferably in the form of a powder.

In some preferred embodiments of the invention, the protein source comprising BLG is in the form of a powder and:
has a total protein content of at least 30-98% w/w relative to the weight of the powder,
has a BLG content of at least 85% w/w relative to total protein,
has a degree of protein denaturation of at most 10%, and
contains at most 1% fat.

In even more preferred embodiments of the invention, the protein source comprising BLG is in the form of a powder and:
has a total protein content of at least 80-98% w/w relative to the weight of the powder,
has a BLG content of at least 90% w/w relative to total protein,
has a degree of protein denaturation of at most 10%, more preferably at most 8%, even more preferably at most 5%, and most preferably at most 2%, and
contains at most 0.5% w/w fat relative to the weight of the powder.

In the most preferred embodiments of the invention, the protein source comprising BLG is in the form of a powder and:
has a total protein content of at least 85-98% w/w relative to the weight of the powder,
has a BLG content of at least 95% w/w relative to total protein,
has a degree of protein denaturation of at most 10%, more preferably at most 8%, even more preferably at most 5%, and most preferably at most 2%, and
contains at most 0.1% fat relative to the weight of the powder.

In other preferred embodiments of the invention, the protein source comprising BLG is in the form of a liquid and:
has a solids content of 1-50% w/w relative to the weight of the liquid,
has a water content of 50-99% w/w relative to the weight of the liquid,
has a total protein content of at least 30-98% w/w relative to total solids,
has a BLG content of at least 85% w/w relative to total protein,
has a degree of protein denaturation of at most 10%, and
contains at most 1% fat relative to total solids.

In even more preferred embodiments of the invention, the protein source comprising BLG is in the form of a liquid and:
has a solids content of 1-50% w/w relative to the weight of the liquid,
has a water content of 50-99% w/w relative to the weight of the liquid,
has a total protein content of at least 80-98% w/w relative to total solids,
has a BLG content of at least 90% w/w relative to total protein,
has a degree of protein denaturation of at most 10%, and
contains at most 0.5% w/w fat relative to total solids.

In the most preferred embodiments of the invention, the protein source comprising BLG is in the form of a liquid and:
has a solids content of 1-50% w/w relative to the weight of the liquid,
has a water content of 50-99% w/w relative to the weight of the liquid,
has a total protein content of at least 85-98% w/w relative to total solids,
has a BLG content of at least 95% w/w relative to total protein,
has a degree of protein denaturation of at most 10%, and
contains at most 0.1% fat relative to total solids.

In some embodiments, the protein source comprising BLG is a WPI or a WPC, wherein BLG constitutes at least 90% w/w of the protein of the protein source, such as at least 95% w/w, at least 96% w/w, at least 97% w/w, at least 98% w/w or at least 99% w/w.

The protein source comprising BLG may be provided as a powder, wherein the protein source provides BLG, e.g. in crystallised and/or isolated form. In some preferred embodiments, the protein source comprising BLG has a BLG crystallinity of at least 10%. WO 2018/115520 describes test methods for determining the crystallinity of BLG in a powder and in a liquid.

Particularly preferred protein sources comprising BLG are those described in the International patent applications WO 2018/115520 and WO 2020/002426, which are incorporated herein by reference.

The one or more batter ingredients often comprise ingredients which contain protein that is not whey protein and which contributes to the total amount of protein of the batter. For example, flour and starch typically contain some protein. Wheat flour may contain about 8-13% w/w protein, wheat cake flour contains about 7-9% w/w protein and wheat starch contains 0.2-1% w/w protein. Similarly, batter ingredient such as eggs, grains, seeds, nuts and fruits may contribute to the total protein content of the aerated batter.

The inventors have found that the aerated batter preferably comprises at most 6% w/w non-dairy protein relative to the weight of the aerated batter. In some preferred embodiments of the invention, the aerated batter comprises at most 5% w/w non-dairy protein, more preferably at most 4% w/w non-dairy protein, even more preferably at most 3% w/w non-dairy protein, and most preferably at most 2% w/w non-dairy protein such as e.g. or at most 1% w/w non-dairy protein.

The inventors have further found that the aerated batter advantageously may comprise at most 8% w/w dairy protein. In some preferred embodiments of the invention, the aerated batter may comprise at most 7% w/w dairy protein, more preferably at most 6% w/w dairy protein, even more preferably at most 5% w/w dairy protein, even more preferably at most 4% w/w dairy protein, and most preferably at most 3% w/w dairy protein.

The protein source comprising BLG is preferably used in an amount sufficient to provide the batter with BLG in an amount in the range of 1-6% w/w, more preferably 1.5-5% w/w and even more preferably 2-4% w/w.

The batter preferably comprises a total amount of protein in the range of 1-10% w/w, more preferably in the range of 1.5-8% w/w, even more preferably in the range of 2-6% w/w and most preferably in the range of 3-5% w/w

The inventors have observed that the present invention is particularly advantageous for low protein batter comprising a total amount of protein in the range of 1.5-4% w/w, and most preferably in the range of 2-3% w/w.

In some preferred embodiments of the invention, the ratio between dairy protein and non-dairy protein may be in the range of 5:1 to 1:5, more preferably 4:1-1:2, and more preferably 3:1-1:1.

The protein source comprising BLG typically contributes with a significant portion of the protein of the batter. In some preferred embodiments of the invention, the protein source comprising BLG contributes with at least 40% w/w of the total amount of protein of the batter, more preferably at least 50% w/w, even more preferably at least 60% w/w, and most preferably at least 70% w/w. In other preferred embodiments of the invention, the protein source comprising BLG contributes with at least 95% w/w of the total amount of protein of the batter, e.g. if the cake is gluten-free.

In further preferred embodiments of the invention, the protein source comprising BLG contributes with 40-95% w/w of the total amount of protein of the batter, more preferably 45-90% w/w, even more preferably 50-80% w/w, and most preferably 55-75% w/w.

Step b. provides one or more batter ingredients and the one or more batter ingredients should comprise one or more of sugar, flour and/or starch. In the context of the present invention, the term “one or more batter ingredients” may be a single ingredient or typically more ingredients, which are used in addition to the protein source comprising BLG.

In the present context, the term “sugar” means sweet-tasting monosaccharides and/or disaccharities. Examples of suitable monosaccharides are glucose, fructose and galactose. Examples of suitable disaccharides are sucrose, lactose and maltose.

In some preferred embodiments of the invention, the one or more batter ingredients comprise or even consist of sugar.

In some preferred embodiments of the invention, the sugar comprises or even consists of glucose.

In other preferred embodiments, the sugar comprises or even consists of sucrose.

In yet other preferred embodiments, the sugar comprises or even consists of sucrose and lactose.

In some preferred embodiments, the invention pertains to method of preparing an aerated batter, the method comprising:
a. Providing a protein source comprising BLG, wherein BLG constitutes at least 85% of the protein of the protein source comprising BLG,
b. Providing one or more batter ingredients comprising sugar,
c. Mixing the one or more batter ingredients with the protein source comprising BLG to form a mixture, and
the method furthermore comprises at least one aeration step, thereby providing the aerated batter.

In some preferred embodiments of the invention, the one or more batter ingredients comprise or even consist of flour. Flour is a powder made by grinding a vegetable source, e.g. grains, roots, bean, nuts or seeds. In some preferred embodiments, the flour is cereal flour such as wheat, rye, oat, barley, maize or rice. The flour may be selected from whole-grain flour or refined flour. In a preferred embodiment of the invention, the at least one ingredient is flour, which flour is cake flour (flour with a low content of gluten protein, e.g. 7-9% w/w) made from wheat. The flour may also be gluten-free and hence contain at most 20 ppm gluten.

In some preferred embodiments, the invention pertains to a method of preparing an aerated batter, the method comprising:
a. Providing a protein source comprising BLG, wherein BLG constitutes at least 85% of the protein of the protein source comprising BLG,
b. Providing one or more batter ingredients comprising flour,
c. Mixing the one or more batter ingredients with the protein source comprising BLG to form a mixture, and
the method furthermore comprises at least one aeration step, thereby providing the aerated batter.

In some preferred embodiments of the invention, the one or more batter ingredients comprises or even consists of starch. In the present context the term starch refers to purified starch used as an ingredient and differs from the starch bound in flour. Starch can be derived from plants like wheat, potatoes, maize, rice and/or cassava. In a preferred embodiment of the invention, the starch is selected from wheat starch, rice starch or maize starch.

In some preferred embodiments, the invention pertains to a method of preparing an aerated batter, the method comprising:
a. Providing a protein source comprising BLG, wherein BLG constitutes at least 85% of the protein of the protein source comprising BLG,
b. Providing one or more batter ingredients comprising starch,
c. Mixing the one or more batter ingredients with the protein source comprising BLG to form a mixture, and
the method furthermore comprises at least one aeration step, thereby providing the aerated batter.

In addition to sugar, flour, and/or starch, the aerated batter may furthermore comprise one or more of fat, oil, egg, egg white, liquid, grains, seeds, nuts, fruits, emulsifiers, hydrocolloids, spices, aroma, flavour, cocoa, colour, stabilizer, preservative, leavening agent, food acids, food bases, and a mixture thereof.

In some preferred embodiments of the invention, the liquid can be water or milk. Milk can be obtained from cows, sheep, goats, camels, mares or any other animal that produces milk suitable for human consumption. Preferably the milk is cow milk. The milk may be pre-processed as desired to adjust protein, fat and/or lactose content to a desired level. The raw material can be selected from whole milk, cream, low fat milk, skim milk, buttermilk, colostrum, low-lactose milk, lactose-free milk, whey protein depleted milk, reconstituted (recombined) milk made from caseinates, milk powder and water, or a combination thereof.

As described above, sugar can be selected from monosaccharides and disaccharides, and mixtures thereof. The aerated batter may comprise in the range of 20-80% w/w sugar. For baking some types of cake, the aerated batter may comprise in the range of 20-50% w/w sugar, preferably in the range of 20-40% w/w sugar, and more preferably in the range of 20-30% w/w sugar. For other types of cakes, the aerated batter may comprises in the range of 50-80% w/w sugar, more preferably in the range of 60-80% w/w sugar, and even more preferably in the range of 70-80% w/w sugar. In some preferred embodiments of the invention, the additional batter ingredient is sugar, wherein the sugar is selected from glucose, fructose, galactose, sucrose, lactose, maltose and mixtures thereof. In some preferred embodiments, the additional batter ingredient is sugar, wherein the sugar is sucrose.

In some preferred embodiments of the invention, the additional batter ingredient is flour. The characteristics of flour is described above. In a preferred embodiment, the additional ingredient is flour, such as flour from wheat, rye, oat and barley. The flour may be selected from whole-grain flour or refined flour. In a preferred embodiment of the invention, the additional batter ingredient is flour, which flour is cake flour, e.g. cake flour made from wheat. The aerated batter may comprise up to 60% w/w flour relative to the weight of the aerated batter. In some preferred embodiments of the invention, the aerated batter comprises flour in an amount in the range of 5-60% w/w, more preferably in the range of 10-60% w/w, even more preferably in the range of 15-50% w/w, and most preferably in the range of 20-40% w/w. In other preferred embodiments of the invention, the aerated batter comprises flour in an amount in the range of 10-20% w/w.

Starch can be used as an additional batter ingredient. In a preferred embodiment of the invention, the additional batter ingredient is starch derived from wheat, potatoes, maize and rice. The starches can be native starches or chemically and/or physically modified. In some preferred embodiments of the invention, starch is used in combination with flour, e.g. a combination of wheat starch and wheat flour. The aerated batter may comprise up to 40% w/w starch relative to the weight of the aerated batter. In some preferred embodiments of the invention, the aerated batter may comprise starch in an amount in the range of 0-30% w/w starch, more preferably in the range of 5-25% w/w, and most preferably in the range of 10-20% w/w.

In some preferred embodiments, the invention pertains to method of preparing an aerated batter, the method comprising:
a. Providing a protein source comprising BLG, wherein BLG constitutes at least 90% of the protein of the protein source comprising BLG,
b. Providing one or more batter ingredients comprising sugar and at least one of: flour and starch,
c. Mixing the one or more batter ingredients with the protein source comprising BLG to form a mixture, and
the method furthermore comprises at least one aeration step, thereby providing the aerated batter.

In other preferred embodiments, the invention pertains to method of preparing an aerated batter, the method comprising:
a. Providing a protein source comprising BLG, wherein BLG constitutes at least 90% of the protein of the protein source comprising BLG, wherein the protein source comprising BLG has a degree of protein denaturation of at most 10%,
b. Providing one or more batter ingredients comprising sugar and at least one of: flour and starch,
c. Mixing the one or more batter ingredients with the protein source comprising BLG to form a mixture, and
the method furthermore comprises at least one aeration step, thereby providing the aerated batter.

In some preferred embodiments, the one or more batter ingredients furthermore comprise fat. The fat may e.g. be selected from animal fat or vegetable fat. The fat may e.g. comprise one or more animal fats, such as a milk fat. The milk fat may be derived from cream, acidified cream and/or butter. The vegetable fat may be selected from the group consisting of maize oil, sesame oil, soya oil, soya bean oil, linseed oil, grape seed oil, rapeseed oil, olive oil, groundnut oil, sunflower oil, safflower oil, palm fat, palm kernel fat, coconut fat, oat oil and a combination thereof.

The aerated batter may comprise from 0 to 35% w/w of fat relative to the weight of the aerated batter, e.g. an oil or fat of vegetable or animal origin. In some preferred embodiments of the invention, no fat and oil is directly added to the aerated batter; the aerated batter comprises only fat added indirectly with a batter ingredient having a fat content. One example of a batter ingredient, which may contribute to the fat content of the aerated batter, is flour. Further, batter ingredients like starch, egg, grains, seeds, nuts, fruits, cocoa, and emulsifiers may indirectly contribute to the fat content of the batter, when used as a batter ingredient. In some preferred embodiments of the invention, the aerated batter comprises at most 5% w/w fat relative to the weight of the batter, preferably at most 4% w/w fat, more preferably at most 3% w/w fat, even more preferably at most 2% w/w fat, and most preferably at most 1% w/w fat. In some preferred embodiments, the aerated batter is fat free, e.g. aerated batter for producing meringue. Aerated batters with such low fat content can be used for baking e.g. meringue, sponge cake and angel food cake.

In some preferred embodiments of the invention, the aerated batter has a fat content in the range of 5-35% w/w. In a more preferred embodiment, the aerated batter has a fat content in the range of 10-30% w/w, more preferably in the range of 15-30% w/w, and most preferably in the range of 20-30% w/w. Examples of cakes, which can be baked from aerated batter with this fat content are pound cake and muffins.

In some preferred embodiments, the invention pertains to a method of preparing an aerated batter, the method comprising:
a. Providing a protein source comprising BLG, wherein BLG constitutes at least 90% of the protein of the protein source comprising BLG, wherein the protein source comprising BLG has a degree of protein denaturation of at most 10%,
b. Providing one or more batter ingredients comprising fat and furthermore comprising at least one of: sugar, flour, and starch,
c. Mixing the one or more batter ingredients with the protein source comprising BLG to form a mixture, and
the method furthermore comprises at least one aeration step, thereby providing the aerated batter.

The present invention enables the replacement or reduction of the use of whole egg or egg white. For some aerated batters, it is desired to use whole egg or egg white in addition to the protein source comprising BLG.

The majority of egg protein present in egg white is ovalbumin, which makes up to 55% of the protein in egg white. Thus, one way of determining the amount of eggs used in an aerated batter is by measuring the amount of ovalbumin of the aerated batter. When using whole eggs or egg whites as an additional ingredient in the present invention, the weight ratio between BLG and ovalbumin of the aerated batter is preferably in the range of 1:1 to 10:1, and more preferably between 2:1-5:1. However, in some preferred embodiments of the invention, the aerated batter does not comprise ovalbumin.

Non-limiting examples of useful emulsifiers to be used in batters are mono- and diglycerides of fatty acids, lactic acid esters of mono- and diglycerides of fatty acids, acetic or lactic acid esters of mono- and diglycerides of fatty acids, diacetyl tartaric acid esters of mono- and diglycerides, polyglycerol monoesters of fatty acids, propylene glycol esters of fatty acid, sodium stearoyl lactylate, polysorbates, sucrose esters of fatty acids and lecithin (canola, soy, sunflower). In some preferred embodiments of the invention, the emulsifier is Emupals 116 (supplied by Palsgaard®) or Monopals 120 (supplied by Palsgaard®).

In some preferred embodiments of the invention, the aerated batter comprises emulsifier in an amount in the range of 0.5-4% w/w, and most preferably 1-3% w/w.

Useful leavening agent are any leavening agent suitable for preparing batters/cakes. The leavening agents as referred to herein are chemical compounds such as baking powder. Baking powder typically comprises a carbon dioxide carrier (typically a salt of bicarbonate) and a leavening acid (typically a low molecular weight organic acid). Generally recognized leavening agents may include monocalcium phosphate (Ca(H₂PO₄)₂), sodium aluminium sulphate (NaAl(SO₄)₂·12H2O), disodium pyrophosphate (Na₂H₂P₂O₇), and sodium aluminium phosphate (NaH₁₄Al₃(PO₄)₈·4H2O and/or Na₃H₁₅Al₂(PO₄)₈).

In some preferred embodiments of the invention, the aerated batter comprises leavening agent in an amount in the range of 0.5-3% w/w, and most preferably 1-2% w/w.

The batter ingredients of the aerated batter may furthermore comprise one or more aroma components, flavour components, hydrocolloids (e.g. locust bean gum, guar gum, tara gum, xanthan gum, carrageenan, acacia gum, cellulose, modified cellulose and pectin), reducing agents (e.g. cysteine or glutathione), oxidants, yeast extract, enzyme active soy flour, cocoa powder, chocolate, colouring agents, and/or enzymes. The skilled artisan knows how to combine these ingredients to obtain the desired type of aerated batter and cake baked from the aerated batter.

The actual amount of protein source comprising BLG in the aerated batter depends on the composition and form of the protein source. If the protein source comprising BLG is used in the form of a powder, a lower dosage of the protein source is required than if it is used in the form of a liquid. However, it the protein source is used on liquid form, it will provide water in addition to protein.

In some preferred embodiments of the invention, the aerated batter comprises or even consists of the following batter ingredients in the specified amounts:
protein source comprising BLG: sufficient to provide BLG in an amount of about 1-6% w/w,
flour (e.g. wheat flour): between about 15% and about 60% w/w,
sugar (e.g. sucrose): between about 20% and about 50% w/w,
starch (e.g. wheat starch): between about 0% and about 30% w/w,
leavening agent (e.g. baking powder): between about 1% and about 4% w/w,
emulsifier: between about 1% and about 4% w/w,
optionally flavour, colour and preservative,
liquid (e.g. water): to reach 100%.

In some preferred embodiments of the invention, the aerated batter comprises or even consists of the following batter ingredients in the specified amounts:
protein source comprising BLG: sufficient to provide BLG in an amount of about 1.5-5% w/w,
flour (e.g. wheat flour): between about 15% and about 40% w/w,
sugar (e.g. sucrose): between about 20% and about 30% w/w,
starch (e.g. wheat starch): between about 10% and about 20% w/w,
leavening agent (e.g. baking powder): between about 1% and about 2% w/w,
emulsifier: between about 2% and about 3% w/w,
optionally flavour, colour and preservative,
liquid (e.g. water): to reach 100%.

In some preferred embodiments of the invention, the aerated batter comprises or even consists of the following batter ingredients in the specified amounts:
protein source comprising BLG: sufficient to provide BLG in an amount of about 1.5-5% w/w,
flour (e.g. fluorinate wheat flour): between about 10% and about 20% w/w,
sugar (e.g. sucrose): between about 20% and about 50% w/w,
sugar, icing: between about 20% and about 50% w/w,
salt: between about 0.5% and about 1% w/w,
tartaric acid: between about 0.05% and about 0.5% w/w,
optionally flavour, colour and preservative,
water: to reach 100%.

In some preferred embodiments of the invention, the aerated batter comprises or even consists of the following batter ingredients in the specified amounts:
protein source comprising BLG: sufficient to provide BLG in an amount of about 2-8% w/w,
flour (e.g. wheat flour): between about 15% and about 60% w/w,
sugar (e.g. sucrose): between about 20% and about 50% w/w,
starch (e.g. wheat starch): between about 0% and about 20% w/w,
vegetable oil: between about 10% and about 35% w/w,
emulsifier: between about 0.5% and about 2% w/w,
optionally flavour, colour and preservative,
water: to reach 100%.

In some preferred embodiments of the invention, the aerated batter comprises or even consists of the following batter ingredients in the specified amounts:
protein source comprising BLG: sufficient to provide BLG in an amount of about 3-6% w/w,
flour (e.g. wheat flour): between about 15% and about 40% w/w,
sugar (e.g. sucrose): between about 20% and about 35% w/w,
starch (e.g. wheat starch): between about 0% and about 15% w/w,
vegetable oil: between about 10% and about 20% w/w,
emulsifier: between about 0.5% and about 2% w/w,
optionally flavour, colour and preservative,
water: to reach 100%.

In some preferred embodiments of the invention, the aerated batter comprises or even consists of the following batter ingredients in the specified amounts:
protein source comprising BLG: sufficient to provide BLG in an amount of about 1-6% w/w,
sugar (e.g. sucrose or glucose): between about 50% and about 80% w/w,
optionally flavour, colour and preservative,
water: to reach 100%.

Step c. involves mixing the one or more batter ingredients and the protein source comprising BLG to form the mixture. The mixing may be a single step mixing where all ingredients are combined and then mixed or it may be a multi-step mixing where one or more batter ingredients, but not all batter ingredients, are mixed with the protein source comprising BLG to form a premix which is subsequently combined and mixed with further ingredients in one or more additional mixing sub-steps. When the protein source is provided in the form of a powder, it is particularly preferred to disperse or dissolve the protein source in an aqueous liquid, preferably water or milk, under gentle mixing conditions and allow it to hydrate for at least 10 minutes, and preferably from 20 minutes-2 hours to make it fully functional.

The temperatures during mixing are typically in the range of 5-60 degrees and more preferably in the range of 10-50 degrees C. It is often preferred to avoid using temperatures above 60 degrees C. to avoid denaturation of BLG prior to the baking step. However, if denaturation is required, such heat-treatments as higher temperatures may be performed.

The method of producing the aerated batter furthermore comprises at least one aeration step.

The batter can be aerated by whipping the batter, e.g. by whipping the batter intensively, whereby air is incorporated into the batter. Whipping of batter can be carried out with standard equipment such as a hand mixer, a Hobart mixer or a batch cooker. Alternatively, the batter can be aerated by use of continuous aeration systems, where a mixing head merges the liquid phase and gas phase. In some preferred embodiments, the batter can be aerated by use of continuous aeration systems, where a mixing head merges the liquid phase and gas phase at the inlet of the mixing head and are homogenized with accurate flow control under controlled pressure, e.g. by use of a Mondo Mixer.

The at least one aeration step preferably involves aerating one or more of:
the protein source comprising BLG,
the one or more batter ingredients,
a premixture made during step c. comprising the protein source comprising BLG and/or the one or more batter ingredients, and
the mixture.

This may be a single aeration step or multiple aeration steps which may be performed in sequence or at different times during the method.

It is often preferred to subject the mixture to a final aeration step, e.g. using the equipment that was used for mixing or alternatively using a dedicated aeration system.

In some preferred embodiments of the invention, the aerated batter has a density in the range of 15-50 g/100 mL, more preferably 20-45 g/100 mL, and most preferably 25-40 g/100 mL.

In some preferred embodiments of the invention, the aerated batter has a density which is reduced by at least 10% relative to the density of the non-aerated batter, more preferably the density of at least 20%, even more preferred at least 30%, and most preferred by at least 50%.

In some preferred embodiments of the invention, the aerated batter has a density which is reduced by at 10-95% relative to the density of the non-aerated batter, more preferably the density of at least 20-90%, even more preferred at least 30-85%, and most preferred by at least 50-85%.

The batter density decreases, when the batter is aerated and air is thereby incorporated into the batter. The more air incorporated, the lower density of the batter. In some preferred embodiments of the invention, the density of the aerated batter is at least 5% lower than same batter, which has not been aerated, preferably the density of the aerated batter is at least 10% lower, such as at least 15% lower, at least 20% lower, at least 25% lower, at least 30% lower, at least 35% lower, at least 40% lower or even at least 50% lower than same batter, which has not been aerated.

Another aspect of the invention pertains to an aerated batter obtainable by the inventive method.

In some preferred embodiments of the invention, the batter is selected from the group consisting of a pound cake batter, a sponge cake batter, an angel food cake batter and a meringue batter.

It may for example be preferred that the batter is a sponge cake batter.

Yet an aspect of the invention pertains to a process for producing a cake which process comprises the steps of the above-mentioned method and furthermore comprises a step of baking the aerated batter. Suitable temperatures and durations for baking cakes are well-known to the person skilled in the art.

Another aspect pertains to a cake obtainable by the process of producing a cake batter.

In particular embodiments, the cake is a cake selected from the group consisting of pound cake, sponge cake, angel food cake and meringue.

When an aerated batter according to the invention is baked, and the aerated batter comprises starch, the transformation of batter into cake is called gelatinization. The gelatinization temperature for cakes typically lies within the range 60-90 degrees C., depending on the choice of ingredients.

In the context of the present invention, the term “bake”, “baked” or “baking” means heating a batter, e.g. the aerated batter of the invention, to obtain a temperature in the core of the batter, which temperature is sufficient for the starch to gelatinize. For aerated batters, which do not comprise starch, e.g. meringue batter, the term “bake”, “baked” or “baking” means heating the meringue batter, e.g. the aerated batter of the invention.

The texture of a cake is important as the consumer of the cake not only enjoys a cake relative to the taste, but very much also on how the cake is perceived with regard to texture and mouth feel.

A cake can be defined by several texture parameters, such as the hardness, resilience and springiness of the cake product.

The texture parameters may be evaluated by performing a Texture Profile Analysis (TPA) on a cake crumb sample obtained from the cake product or the whole (i.e. entire) cake product. The TPA may be performed with any system known by the skilled person to perform a TPA. For example, such a system may be a Texture Analyser (e.g. TAXT2i, Stable Micro Systems). More particularly, the texture parameters, such as hardness, resilience and springiness of the cake product can be calculated from the force-time curve registered when performing a TPA on a cake sample using a Texture Analyser. In TPA, two consecutive deformations with a short waiting time in between the deformations are applied on a cake crumb sample and the force registered by the load cell of the texture analyser is measured as a function of time. For example, two consecutive deformations of a cylindrical cake crumb sample (e.g. with a diameter of 45 mm and a height of 40 mm) with a cylindrical probe (e.g. with a diameter of 100 mm) with a maximum deformation of 50% of the initial height of the product may be performed at a deformation speed of 2 mm/s and a waiting time between the two consecutive deformations of 3 s. The force needed to deform the sample may be recorded as a function of time (i.e. force-time curve).

A value of 100 may be set for the respective texture parameters of a cake crumb sample that is used as reference sample in a given test (e.g. a cake crumb sample of a cake product prepared from cake batter comprising chlorinated flour instead of the chlorinated flour replacer as described herein). The parameter values of cake crumb samples different from said reference sample may be expressed relative to this reference sample.

The term “hardness” as used herein refers to the maximal force needed to apply a defined deformation (e.g. a fixed deformation of 50% of the initial height of the cake crumb sample or the whole cake product) to a cake crumb sample of the cake product or the whole cake product. The term “hardness” may also refer to the sense related to the force required to compress the cake crumb sample or the whole cake product.

The term “resilience” as used herein refers to the speed (and degree) at which a cake crumb sample of the cake product or the whole cake product returns to its original shape after a certain deformation. It is a measure for how well a product “fights to regain its original height” after a deformation has been applied. The resilience is calculated as the ratio (in %) between the surface under the first deformation curve when the probe is moving upwards to the surface under the first deformation curve when the probe is moving downwards. One way of measuring the texture of a baked product is by measuring the resilience of the product.

The term “springiness” as used herein refers to an expression of how well a cake product physically springs back after it has been deformed during the first compression of the TPA method as described elsewhere herein and has been allowed to wait for the target wait time between deformations. The springiness may be calculated as the height (in %) of the cake crumb sample after the first deformation and 3 sec of rest compared to the initial height of the cake crumb sample.

The volume of a cake baked from the aerated batter according to the invention may increase with at least 5% compared to the volume of cakes baked from batter that has not been aerated. In some preferred embodiments of the invention, the protein source comprising BLG increases the volume of a cake with at least 10% compared to the volume of a cake baked from non-aerated batter, such as at least 15%, at least 20%, at least 25%, at least 30%, at least 35%, at least 40%, at least 45% or at least 50%.

The present invention also provides cake mixes and cake premixes comprising batter ingredients and the protein source comprising BLG, wherein the BLG constitutes at least 85% of the protein of the protein source. Preferably, said cake mixes and cake premixes are suitable for preparing the aerated batter according to the invention. On the one hand, a cake mix typically comprises all dry ingredients of the cake batter as described herein (i.e. all ingredients of the cake batter as described herein with the exception of water). The skilled person will understand that the addition of liquid to the cake mix may allow obtaining an aerated batter according to the invention.

In one aspect, the invention pertains to a cake mix or a cake premix, which is a powder composition suitable for making an aerated batter, which powder composition comprises one or more batter ingredients and a protein source comprising BLG, wherein the BLG constitutes at least 85% of the protein of the protein source, and where the one or more batter ingredients are dry and comprises at least one of sugar, flour and starch. The powder composition can be used for preparing an aerated batter according to the invention. In addition to the one or more batter ingredients, the power composition may comprise an additional batter ingredient, e.g. an ingredient selected from the group consisting of sugar, flour, starch, fat, oil, egg, liquid, grains, seeds, nuts, fruits, emulsifiers, hydrocolloids, spices, aroma, flavour, cocoa, colour, stabilizer, preservative, leavening agent, and a mixture thereof.

In one aspect, the invention further concerns a method of producing a powder composition such as a cake mix or cake premix according to the invention, wherein the method comprises:
i) Providing one or more batter ingredients and a protein source comprising BLG, wherein the BLG constitutes at least 85% of the protein of the protein source,
ii) mixing the one or more batter ingredients and the protein source comprising BLG to form a powder composition, and
iii) optionally, packaging the powder composition,
wherein the one or more batter ingredients comprise at least one of sugar, flour and starch.

In some preferred embodiments, the method of producing a powder composition comprises:
i) Providing one or more batter ingredients and a protein source comprising BLG, wherein the BLG constitutes at least 85% of the protein of the protein source,
ii) mixing the one or more batter ingredients and the protein source comprising BLG to form a powder composition, and
iii) optionally, packaging the powder composition,
wherein the one or more batter ingredients comprise at least one of sugar, flour and starch.

Preferred numbered embodiments of the invention are described in the following:

Embodiment 1. A method of preparing an aerated batter, the method comprising:
a. Providing a protein source comprising beta-lactoglobulin (BLG), wherein BLG constitutes at least 85% of the protein of the protein source comprising BLG,
b. Providing one or more batter ingredients comprising at least one of: sugar, flour, and starch,
c. Mixing the one or more batter ingredients with the protein source comprising BLG to form a mixture, and
the method furthermore comprises at least one aeration step, thereby providing the aerated batter.

Embodiment 2. The method according to Embodiment 1 wherein the at least one aeration step involves aerating one or more of:
the protein source comprising BLG,
the one or more batter ingredients,
a premixture made during step c. comprising the protein source comprising BLG and/or the one or more batter ingredients, and
the mixture.

Embodiment 3. The method according to Embodiment 1 or 2, wherein BLG constitutes at least 90% w/w of the protein of the protein source comprising BLG, more preferably at least 95% w/w, even more preferably at least 96% w/w, and most preferably at least 97% w/w.

Embodiment 4. The method according to any of the preceding Embodiments, wherein the protein source comprising BLG has a degree of protein denaturation of at most 90%, more preferably at most 70%, even more preferably at most 50%, and most preferably at most 30%.

Embodiment 5. The method according to any of the preceding Embodiments, wherein the protein source comprising BLG has a degree of protein denaturation of at most 10%, more preferably at most 8%, even more preferably at most 5%, and most preferably at most 2%.

Embodiment 6. The method according to any of the preceding Embodiments, wherein the protein source comprising BLG comprises at most 10% CMP to total protein, more preferably at most 8% CMP relative to total protein, even more preferably at most 6% CMP relative to total protein, and most preferably at most 4% CMP relative to total protein.

Embodiment 7. The method according to any of the preceding Embodiments, wherein the protein source comprising BLG is substantially free of CMP.

Embodiment 8. The method according to any of the preceding Embodiments, wherein the protein source comprising BLG is provided as a powder and/or a liquid.

Embodiment 9. The method according to any of the preceding Embodiments, wherein the batter comprises at most 6.0 wt % non-dairy protein relative to the weight of the batter.

Embodiment 10. The method according to any of the preceding Embodiments, wherein the batter comprises at most 8.0 wt % dairy protein relative to the weight of the batter.

Embodiment 11. The method according to any of the preceding Embodiments, wherein the ratio between dairy protein and non-dairy protein is in the range of 5:1 to 1:5.

Embodiment 12. The method according to any of the preceding Embodiments, wherein the one or more batter ingredients can be selected from sugar, flour, starch, fat, oil, egg, liquid, grains, seeds, nuts, fruits, emulsifiers, hydrocolloids, spices, aroma, flavour, cocoa, colour, stabilizer, preservative, leavening agent, and a mixture thereof.

Embodiment 13. The method according to any of the preceding Embodiments, wherein the batter comprises in the range of 0-30% w/w fat relative to the weight of the batter.

Embodiment 14. The method according to any of the preceding Embodiments, wherein the batter comprises in the range of 0-60% w/w flour based weight of the batter.

Embodiment 15. The method according to any of the preceding Embodiments, wherein the batter comprises in the range of 20-80% w/w sugar relative to the weight of the batter.

Embodiment 16. The method according to any of the preceding Embodiments, wherein the batter comprises at most 1% w/w fat relative to the weight of the batter.

Embodiment 17. The method according to Embodiment 15, wherein the batter is meringue batter, sponge cake batter or angel food cake batter.

Embodiment 18. The method according to Embodiments 1-14, wherein the batter has a fat content in the range of 5-35% w/w, such as in the range of 10-30% w/w, in the range of 15-30% w/w or in the range of 20-30% w/w.

Embodiment 19. The method according to Embodiment 18, wherein the batter is pound cake batter or a muffin.

Embodiment 20. The method according to any of the preceding Embodiments, wherein the ratio between BLG and ovalbumin of the aerated batter is from 1:1 to 10:1.

Embodiment 21. The method according to any of the preceding Embodiments, wherein the batter does not comprise ovalbumin.

Embodiment 22. The method according to any of the preceding Embodiments, wherein the batter is aerated by whipping, intense whipping or by use of continuous aeration systems.

Embodiment 23. Aerated batter obtainable by any of Embodiments 1-22.

Embodiment 24. Cake obtainable by baking the aerated batter according to Embodiment 23.

Embodiment 25. Use of a protein source comprising BLG in an aerated batter, wherein the BLG constitutes at least 85% of the protein in the protein source.

Embodiment 26. Use according to Embodiment 25, wherein the protein source comprising BLG is provided as a liquid or a powder.

Embodiment 27. Use according to Embodiments 25-26, wherein the protein source comprising BLG is substantially free of cGMP.

Embodiment 28. Use according to any of Embodiments 25-27, wherein the protein source comprising BLG
a) contains at least 10% w/w native BLG relative to the amount of BLG in the protein source, or
b) comprises BLG, wherein the BLG constitutes at least 90% of the protein in the protein source.

Embodiment 29. Use according to any of Embodiments 25-28, wherein the protein source comprising BLG partly or fully replaces egg protein.

Embodiment 30. Use according to any of Embodiments 25-29, wherein the protein source comprising BLG
a. decreases density of an aerated batter, compared to same batter, which has not been aerated,
b. increases volume of a cake baked from the aerated batter, compared to a cake baked from same batter, which has not been aerated,
c. improves cake texture of a cake baked from the aerated batter, compared to a cake baked from same batter, which has not been aerated,
d. improves crumb strength of a cake baked from the aerated batter, compared to a cake baked from same batter, which has not been aerated,
e. improves crumb resilience of a cake baked from the aerated batter, compared to a cake baked from same batter, which has not been aerated, and/or
f. improves crumb stability of a cake baked from the aerated batter, compared to a cake baked from same batter, which has not been aerated.

Embodiment 31. Powder composition suitable for making an aerated batter, which powder composition comprises one or more batter ingredients and a protein source comprising BLG, wherein the BLG constitutes at least 85% of the protein of the protein source, and where the one or more batter ingredients are dry and comprises at least one of sugar, flour and starch.

Embodiment 32. Powder composition according to Embodiment 31, wherein the powder compostion further comprises batter ingredients selected from the group consisting sugar, flour, starch, fat, oil, egg, liquid, grains, seeds, nuts, fruits, emulsifiers, hydrocolloids, spices, aroma, flavour, cocoa, colour, stabilizer, preservative, leavening agent, and a mixture thereof.

Embodiment 33. Method of producing a powder composition according to any of Embodiments 31-32, wherein the method comprises:
a. Providing one or more batter ingredients and a protein source comprising BLG, wherein the BLG constitutes at least 85% of the protein of the protein source,
b. mixing the one or more batter ingredients and the protein source comprising BLG to form a powder composition, and
c. optionally, packaging the powder composition,
wherein the batter ingredient comprises at least one of sugar, flour and starch.

The present invention has been described above with reference to specific embodiments. However, other embodiments than the above described are equally possible within the scope of the invention. The different features and steps of various embodiments and aspects of the invention may be combined in other ways than those described herein unless it is stated otherwise.

### EXAMPLES

### Example 1: Methods of Analysis

### Example 1.1: Determination of Protein Nativeness by Intrinsic Tryptophan Fluorescence

Tryptophan (Trp) fluorescence spectroscopy is a well-described tool to monitor protein folding and unfolding. Trp residues buried within native proteins typically display highest fluorescence emission around 330 nm than when present in more solvent exposed positions, such as unfolded proteins. In unfolded proteins, the wavelengths for Trp fluorescence emission typically shift to higher wavelengths and are often measured around 350 nm. We here exploit this transition to monitor thermally induced unfolding by calculating the ratio between fluorescence emission at 330 nm and 350 nm to investigate the influence of heating temperature.

The analysis comprises the following steps:
Protein source were diluted to 0.6 mg/ml in MQ water.
300 μl sample was transferred to white 96-well plate avoiding bubbles or 3 mL was transferred to 10 mm quartz cuvette.
The tryptophan fluorescence emission intensity between 310 and 400 nm was recorded from the top by excitation at 295 using 5 nm slits.
Samples were measured at 22 degrees C. using a Cary Eclipse fluorescence spectrophotometer equipped with a plate reader accessory (G9810A) or single cuvette holder.
The emission intensity ratio was calculated by dividing the measured fluorescence emission intensity at 330 nm with the emission intensity at 350 nm, R=1330/1350, and used as a measure of protein nativity.
   R of at least 1.11 describes a predominant native BLG conformation and
   R of less than 1.11 reports on at least partial unfolding and aggregation.

### Example 1.2: Determination of the Degree of Protein Denaturation of a Whey Protein Composition

Denatured whey protein is known to have a lower solubility at pH 4.6 than at pH values below or above pH 4.6. Therefore, the degree of denaturation of a whey protein composition is determined by measuring the amount of soluble protein at pH 4.6 relative to the total amount of protein at a pH where the proteins of the solution are stable.

More specifically for whey proteins, the whey protein composition to be analysed (e.g. a powder or an aqueous solution) is converted to:
a first aqueous solution containing 5.0% (w/w) total protein and having a pH of 7.0 or 3.0, and
a second aqueous solution containing 5.0% (w/w) total protein and having a pH of 4.6.

pH adjustments are made using 3% (w/w) NaOH (aq) or 5% (w/w) HCl (aq).

The total protein content (P_{pH 7.0 or 3.0}) of the first aqueous solution is determined according to example 1.5.

The second aqueous solution is stored for 2 h at room temperature and subsequently centrifuged at 3000 g for 5 minutes. A sample of the supernatant is recovered and analysed according to Example 1.5 to give the protein concentration in the supernatant (S_{pH4.6}).

The degree of protein denaturation, D, of the whey protein composition is calculated as:

D=((P_{pH 7.0 or 3.0}-S_{pH 4.6})/P_{pH 7.0 or 3.0})*100%

### Example 1.3 Determination of Protein Denaturation (with pH 4.6 Acid Precipitation) Using Reverse Phase UPLC Analysis

BLG samples (such as non-heated reference and heated BLG beverage compositions) were diluted to 2% in MQ water. 5 mL protein solution, 10 mL Milli-Q, 4 mL 10% acetic acid and 6 mL 1.0M NaOAc are mixed and stirred for 20 minutes to allow precipitation agglomeration of denatured protein around pH 4.6. The solution is filtered through 0.22 μm filter to remove agglomerates and non-native proteins.

All samples were subjected to the same degree of dilution by adding polished water. For each sample, the same volume was loaded on an UPLC system with a UPLC column (Protein BEH C4; 300 Å; 1.7 μm; 150×2.1 mm) and detected at 214 nm. The samples were run using the following conditions:
Buffer A: Milli-Q water, 0.1% w/w TFA
Buffer B: HPLC grade acetonitrile, 0.1% w/w TFA
Flow: 0.4 ml/min
Gradient: 0-6.00 minutes 24-45% B; 6.00-6.50 minutes 45-90% B; 6.50-7.00 minutes 90% B; 7.00-7.50 minutes 90-24% B and 7.50-10.00 minutes 24% B.

The area of BLG peaks against a protein standard (Sigma L0130) was used to determine the concentration of native bLG in samples (5 level calibration curve) Samples were diluted further and reinjected if outside linear range.

### Example 1.4: Determination Total Protein

The total protein content (true protein) of a sample is determined by:
1) Determining the total nitrogen of the sample following ISO 8968-1/2|IDF 020-1/2-Milk-Determination of nitrogen content—Part 1/2: Determination of nitrogen content using the Kjeldahl method.
2) Determining the non-protein nitrogen of the sample following ISO 8968-4|IDF 020-4-Milk—Determination of nitrogen content—Part 4: Determination of non-protein-nitrogen content.
3) Calculating the total amount protein as (m_{total nitrogen}−m_{non-protein-nitrogen})*6.38.

### Example 1.5: Determination of Non-Aggregated BLG, ALA, and CMP

The content of non-aggregated alpha-lactalbumin (ALA), BLG and caseinomacropeptide (CMP), respectively, was analysed by HPLC analysis at 0.4 mL/min. 25 microL filtered sample is injected onto 2 TSKgel3000PWxl (7.8 mm 30 cm, Tosohass, Japan) columns connected in series with attached pre-column PWxl (6 mm×4 cm, Tosohass, Japan) equilibrated in the eluent (consisting of 465 g Milli-Q water, 417.3 g acetonitrile and 1 mL triflouroacetic acid) and using a UV detector at 210 nm.

Quantitative determination of the contents of native alpha-lactalbumin (Cₐₗₚₕₐ), beta-lactoglobulin (C_{beta}), and caseinomacropeptide (C_{CMP}) was performed by comparing the peak areas obtained for the corresponding standard proteins with those of the samples.

The total amount of additional protein (non-BLG protein) was determined by subtracting the amount of BLG from the amount of total protein (determined according to Example 1.4)

### Example 1.6: Determination of pH

All pH values are measured using a pH glass electrode and are normalised to 25 degrees C. The pH glass electrode (having temperature compensation) is rinsed carefully before and calibrated before use.

When the sample is in liquid form, the pH is measured directly in the liquid solution at 25 degrees C.

When the sample is a powder, 10 gram of a powder is dissolved in 90 ml of demineralised water at room temperature while stirring vigorously. The pH of the solution is then measured at 25 degrees C.

### Example 1.7: Determination of the Water Content of a Powder

The water content of a food product is determined according to ISO 5537:2004 (Dried milk—Determination of moisture content (Reference method)). NMKL is an abbreviation for “Nordisk Metodikkomité for Næringsmidler”.

### Example 1.8: Determination of the Total Amount of BLG, ALA, and CMP

This procedure is a liquid chromatographic (HPLC) method of the quantitative analysis of proteins such as ALA, BLG and CMP and optionally also other protein species in a composition. Contrary to the method of Example 1.6, the present method also measures proteins that are present in aggregated form and therefore provides a measure of the total amount of the protein species in the composition in question.

The mode of separation is Size Exclusion Chromatography (SEC) and the method uses 6M Guanidine HCI buffer as both sample solvent and HPLC mobile phase. Mercaptoethanol is used as a reducing agent to reduce the disulphide (S—S) in the proteins or protein aggregates to create unfolded monomeric structures.

The sample preparation is easily achieved by dissolving 10 mg protein equivalent in the mobile phase.

Two TSK-GEL G3000SWXL (7.7 mm×30.0 cm) columns (GPC columns) and a guard column are placed in series to achieve adequate separation of the major proteins in raw materials.

The eluted analytes are detected and quantified by UV detection (280 nm).

Equipment/Materials:
1. HPLC Pump 515 with manual seal wash (Waters)
2. HPLC Pump Controller Module II (Waters)
3. Autosampler 717 (Waters)
4. Dual Absorbance Detector 2487 (Waters)
5. Computer software capable of generating quantitative reports (Empower 3, Waters)
6. Analytical column: Two TSK-GEL G3000SWXL (7.8×300 mm, P/N: 08541).
Guard Column: TSK-Guard Column SWxL (6.0×40 mm, P/N: 08543).
7. Ultrasonic Bath (Branson 5200)
8. 25 mm Syringe filter with 0.2 μm Cellulose Acetate membrane. (514-0060, VWR)

Procedure:

Mobile Phase:
A. Stock buffer solution.
   1. Weigh 56.6 g of Na₂HPO₄, 3.5 g of NaH₂PO₄, and 2.9 g of EDTA in to a 1000 mL beaker. Dissolve in 800 mL of water.
   2. Measure pH and adjust to 7.5±0.1, if necessary, with HCl (decrease pH) or NaOH (increase pH).
   3. Transfer to a 1000 mL volumetric flask and dilute to volume with water.
B. 6M Guanidine HCl Mobile Phase.
   1. Weigh 1146 g of Guanidine HCl in to a 2000 mL beaker, and add 200 mL of the stock buffer solution(A)
   2. Dilute this solution to about 1600 mL with water while mixing with a magnetic stir bar (50° C.)
   3. Adjust the pH to 7.5±0.1 with NaOH.
   4. Transfer into a 2000 mL volumetric flask and dilute to volume with water.
   5. Filter using the solvent filtration apparatus with the 0.22 μm membrane filter.

Calibration Standards.

Calibration standards of each protein to be quantified are prepared the following way:
1. Weigh accurately (to 0.01 mg) about 25 mg of the protein reference standard into a 10 mL volumetric flask and dissolve in 10 mL of water.
This is the protein stock standard solution (51) of the protein
2. Pipette 200 μl of 51 into a 20 ml volumetric flask and dilute to volume with mobile phase.
This is the low working standard solution WS1.
3. Pipette 500 μL of 51 into a 10 mL volumetric flask and dilute to volume with mobile phase.
This is standard solution WS2.
4. Pipette 500 μL of 51 into a 5 mL volumetric flask and dilute to volume with mobile phase.
This is standard solution WS3.
5. Pipette 750 μL of 51 into a 5 mL volumetric flask and dilute to volume with mobile phase.
This is standard solution WS4.
6. Pipette 1.0 mL of 51 into a 5 mL volumetric flask and dilute to volume with mobile phase.
This is the high working standard solution WS5.
7. Using graduated disposable pipettes, transfer 1.5 mL of WS1-5 into separate vials.
Add 10 μL of 2-mercaptoethanol to each vial and cap. Vortex the solutions for 10 sec. Let the standards stay at ambient temperature for about 1 hr.
8. Filter the standards using 0.22 μm Cellulose Acetate syringe filters.

The purity of protein is measured using Kjeldahl (N×6.38) and the area % from standard solution WS5 using the HPLC.

protein (mg)=“protein standard weight” (mg)×P1×P2

P1=P% (Kjeldahl)

P2=protein area % (HPLC)

Sample Preparation
1. Weigh the equivalent of 25 mg of protein of the original sample into a 25 mL volumetric flask.
2. Add approximately 20 mL of mobile phase and let the sample dissolve for about 30 min.
3. Add mobile phase to volume and add 167 μL of 2-mercaptoethanol to the 25 ml sample solution.
4. Sonicate for about 30 min and afterwards let the sample stay at ambient temperature for about 1½ hours.
5. Mix the solution and filter using 0.22 μl Cellulose Acetate syringe filters.

HPLC System/Columns

Column Equilibration
1. Connect the GPC guard column and the two GPC analytical columns in series. New columns are generally shipped in a phosphate-salt buffer.
2. Run water through a new column gradually from 0.1 to 0.5 mL/min in 30 to 60 mins. Continue flushing for about 1 hour.
3. Gradually decrease flow rate from 0.5 mL/min to 0.1 mL/min and replace with mobile phase in the reservoir.
4. Increase pump flow rate gradually from 0.1 to 0.5 mL/min in 30 to 60 mins to avoid pressure shock and leave at 0.5 mL/min.
5. Inject ten samples to allow the column to be saturated and wait for the peaks to elute.
This will aid in the conditioning of the column.
This step is done without the need of waiting for each injection to be complete before injecting the next.
6. Equilibrate with the mobile phase at least 1 hour.

Calculation of the Results

Quantitative determination of the contents of the proteins to be quantified, e.g. alpha-lactalbumin, beta-lactoglobulin, and caseinomacropeptide, is performed by comparing the peak areas obtained for the corresponding standard proteins with those of the samples. The results are reported as g specific protein/100 g of the original sample or weight percentage of the specific protein relative to the weight of the original sample.

### Example 1.9: Determination of the Total Amount of Carbohydrate

The amount of carbohydrate is determined by use of Sigma Aldrich Total Carbohydrate Assay Kit (Cat MAK104-1KT) in which carbohydrates are hydrolysed and converted to furfural and hydroxyfurfurals which are converted to a chromagen that is monitored spectrophotometrically at 490 nm.

### Example 1.10: Determination of the Total Amount of Fat

The amount of fat is determined according to ISO 1211:2010 (Determination of Fat Content—Röse-Gottlieb Gravimetric Method).

### Example 2: Replacing Whole Egg with a High BLG Protein Source in Aerated Batters

The purpose of these experiments were to investigate the initial findings of the inventors with respect to the beneficial effects of protein sources with high BLG purity in aerated batters.

Materials and Methods:

6 different sponge cake variants were prepared (3-4 individual cakes of each variant) using the ingredients and process below.

| | 1: | | | | | 6: BLG |
|---|---|---|---|---|---|---|
| | Refer- | | | | | (20% |
| Ingredients (% | ence | 2: | 3: | 4: | 5: | less |
| w/w) | (egg) | 80CV200 | SPC | BLG | SPIR | protein) |
| Sponge cake test | 59.5 | 59.2 | 59.2 | 59.2 | 59.2 | 59.2 |
| mix | | | | | | |
| Tap water | 14.1 | 33.7 | 33.7 | 33.7 | 33.7 | 33.7 |
| Emulsifier (Emul- | 1.5 | 2.3 | 2.3 | 2.3 | 2.3 | 2.3 |
| pals 116) | | | | | | |
| Whole eggs | 25.0 | | | | | |
| 80CV200 | | 4.8 | | | | |
| SPC | | | 4.1 | | | |
| BLG powder | | | | 3.8 | | 3.1 |
| SPIR | | | | | 3.9 | |

Sponge cake test mix: 29.7% w/w wheat cake flour (approx. 8% protein), 42.1% w/w sucrose, 25.3% w/w wheat starch, 2.9% w/w baking powder
Whole eggs: (12% w/w protein, approx. 25% w/w total solids, approx. 75% water)
80CV200: WPC80 powder prepared from acid whey (a BLG content of approx. 62% w/w of total protein, approx. 76% w/w protein)
SPC: milk serum protein concentration powder prepared from milk serum (primarily native protein, a BLG content of approx. 62% w/w of total protein, approx. 73% total protein)
BLG powder: BLG isolate powder prepared as outlined is Example 7 of WO 2018/115520 and having a degree of protein denaturation of less than 5% and a BLG content of approx. 97% w/w of total protein and a protein content of approx. 85% w/w
SPIR: milk serum protein isolate prepared from milk serum (primarily native protein, a BLG content of approx. 62% w/w of total protein, approx. 85% total protein)

Process:
Dissolve the protein source in water and let it hydrate for 1 hour with magnetic stirring at room temperature (the whole egg variant did not undergo the test)
Adjust the pH of the protein solution to 7
Mix all ingredients using a Hobart N50 with whip to obtain 1000 g batter in the bowl
Mix at 1^{st} speed for 10 seconds
Mix at 3^{rd} gear for 5 minutes
Scale 250 g in small sponge cake tins (15 cm diameter)
Bake in deck oven at 185° C. for 30 minutes
Cool and pack the baked cakes
Evaluate the cakes the day after by measurement of volume, and by Texture Profile Analysis (TPA) using a TextureAnalyser to determine the hardness, springiness, and resilience of the cake.

The densities of the aerated batters were measured separately.

Results:

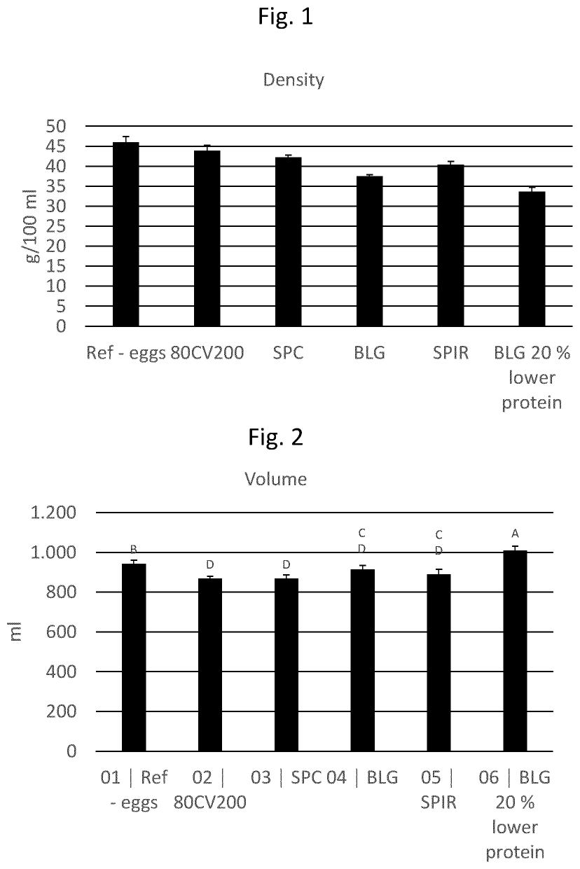

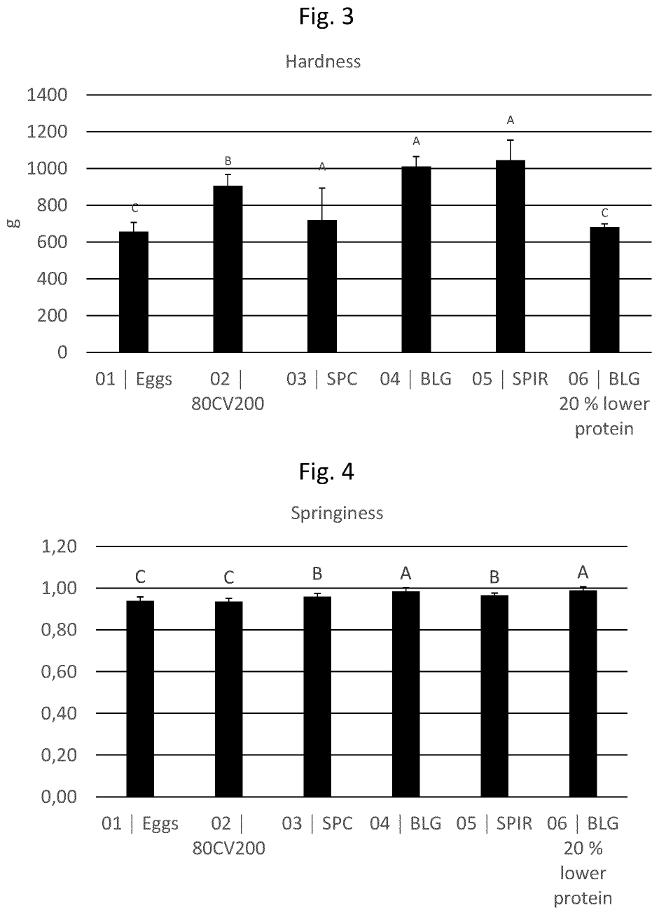

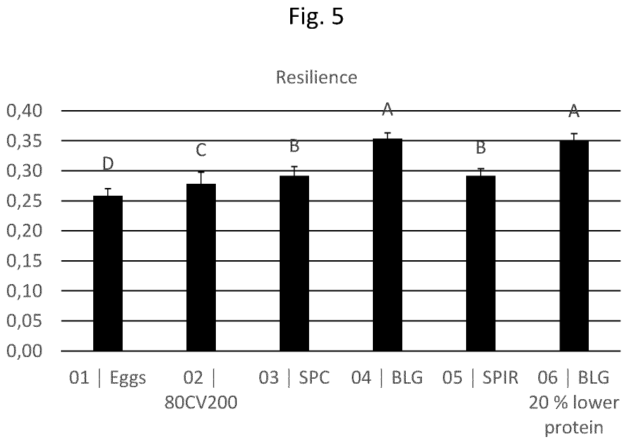

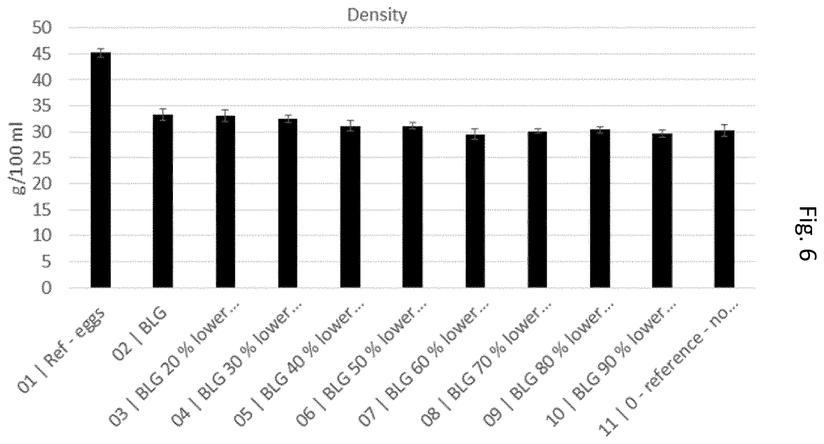

The obtained results are illustrated in FIG. 1 (density of the aerated batters, FIG. 2 (volume of the cakes), FIG. 3 (hardness of the cakes), FIG. 4 (springiness of the cakes), and FIG. 5 (resilience of the cakes).

As shown in FIG. 1, the density the aerated batters when using BLG (variant 04) became lower, even if the batter contained 20% less protein (variant 06), compared to a reference containing eggs (variant 01), a WPC from acid whey (variant 02), an SPC (variant 03) and an SPI (variant 05).

As shown in FIG. 2, the volume obtained for variant 06 (BLG powder but 20% lower protein content) was significantly higher than for the rest of the samples. Also, the reference (variant 01) was significantly different from the other samples. The rest of the variants did not have statistically significant differences in volume but had volumes that were lower than both variant 01 and variant 06.

As shown in FIG. 3, the hardness of the egg-reference (variant 01) was comparable with the cake containing 20% lower BLG powder dosage (variant 06). The rest of the variants had a significantly higher hardness. The springiness (see FIG. 4) were significantly higher for both the BLG powder variants (variants 04 and 06). The cakes containing SPC or SPIR (variants 03 and 05) had a comparable springiness but were both lower than the springiness of the BLG powder-variants. The reference variant and the cake containing WPC80 from acid whey (variants 01 and 02) had a springiness which was lower than the other variants. With respect to resilience (see FIG. 5), the results were quite similar for both BLG powder variants (04 and 06) which also had the highest resilience of all variants. The reference variant had a significantly lower resilience than all other samples. It was surprising to observe that a reduction in the dosage of BLG powder did not affect the resilience of the cake.

Conclusion:

The high purity BLG powder was found to provide a higher cake resilience and cake springiness than whole egg and traditional whey protein concentrates/isolates and to provide a higher volume and a lower cake density.

Even when reducing the amount of BLG by 20% relative to the full dosage, the resulting cake still had a higher volume, a lower density, and a higher resilience than the reference cake containing eggs.

### Example 3: High BLG Protein Sources Enabled Reduced Protein Content in Aerated Batter

As mentioned above in Example 2, the inventors have observed that high BLG protein sources make it possible to reduce the protein content of an aerated batter and in the subsequent baked cake. In Example 3, the inventors have investigated the impact of reducing the content of BLG powder in an aerated batter. The inventors prepared eight cake variants according to the invention (variants 2-10) and compared these against a first reference cake comprising whole eggs (variant 1) and a second reference batter comprising neither eggs nor BLG powder (variant 11). 3-4 individual cakes of each cake variant were produced.

Materials and Methods:

The ingredients and process of Example 2 was also used in Example 3 in the amounts described below.

| | | | | | | | | | | | 11: |
|---|---|---|---|---|---|---|---|---|---|---|---|
| | | | | | | | | | | | 0- |
| | | | 03: | 04: | 05: | 06: | 07: | 08: | 09: | 10: | reference |
| | 01: | | BLG | BLG | BLG | BLG | BLG | BLG | BLG | BLG | no |
| Ingredients | Reference | | 20% | 30% | 40% | 50% | 60% | 70% | 80% | 90% | protein |
| (% | with | 02: | lower | lower | lower | lower | lower | lower | lower | lower | and |
| w/w) | eggs | BLG | prot. | prot. | prot. | prot. | prot. | prot. | prot. | prot. | eggs |
| Sponge cake test | 59.5 | 59.2 | 59.2 | 59.2 | 59.2 | 59.2 | 62.5 | 62.9 | 63.3 | 63.6 | 64.0 |
| mix | | | | | | | | | | | |
| Tap water | 14.1 | 33.7 | 33.7 | 33.7 | 33.7 | 33.7 | 33.7 | 33.7 | 33.7 | 33.7 | 33.7 |
| Emulpals 116 | 1.5 | 2.3 | 2.3 | 2.3 | 2.3 | 2.3 | 2.3 | 2.3 | 2.3 | 2.3 | 2.3 |
| Whole eggs | 25.0 | | | | | | | | | | |
| BLG powder | | 3.83 | 3.07 | 2.54 | 2.18 | 1.82 | 1.53 | 1.15 | 0.77 | 0.38 | 0.0 |

Results:

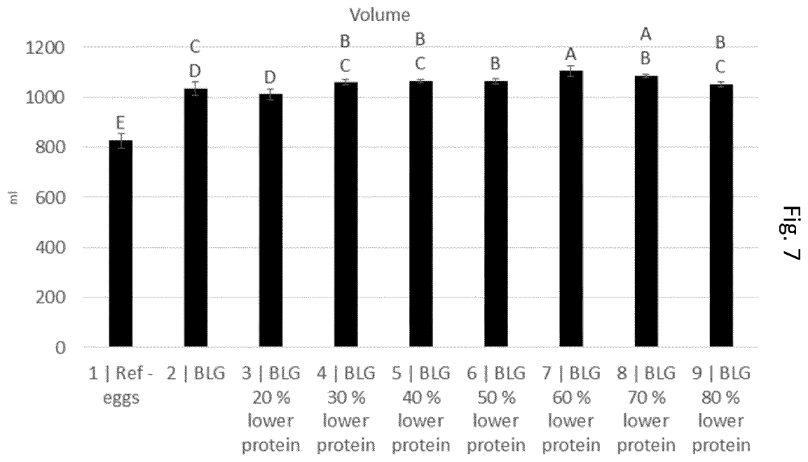

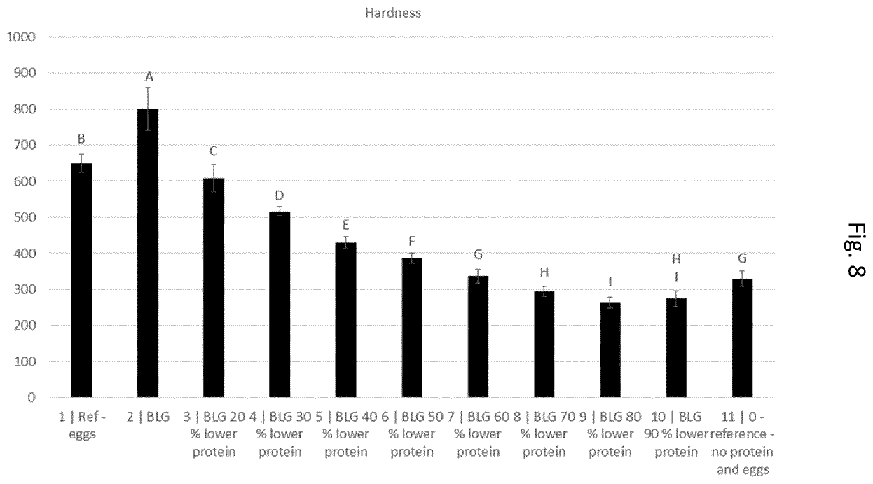

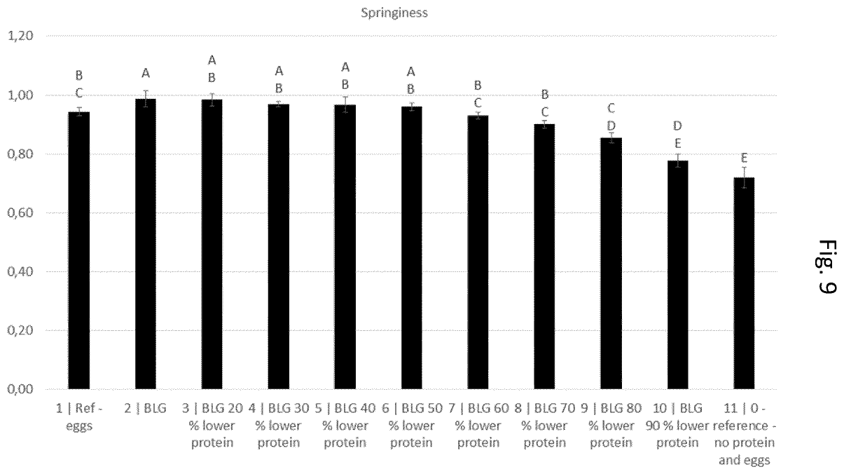

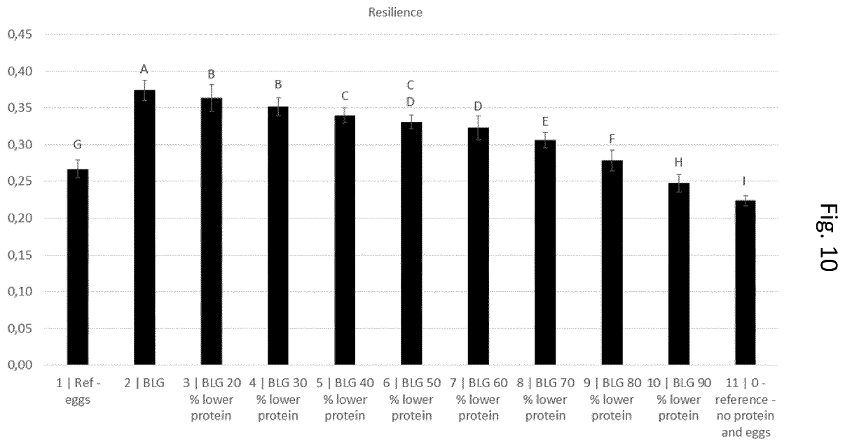

The obtained results are illustrated in FIG. 6 (density of the aerated batters), FIG. 7 (volume of the cakes), FIG. 8 (hardness of the cakes), FIG. 9 (springiness of the cakes), and FIG. 10 (resilience of the cakes).

As shown in FIG. 6, the density of the egg-containing reference (variant 1) was higher than for all other variants. The density was reduced by addition of BLG powder but seemed to decrease further by reduction of the dosage of the BLG powder. With regards to volume (FIG. 7), the replacement of whole egg with BLG the reference (variant 1) significantly increased the volume of the cakes (variants 2-9). The cake variants 2-5 and 9 appeared to have similar volume whereas variants 7 and 8 provided a slightly higher volume.

The hardness of the cake variants was reduced by reduced dosage of the BLG powder and hence a lower content of protein. The last two variants (10-11) became fragile on the outside and compact in the centre and were therefore not significantly lower in hardness due to the firm centre measured by TPA.

With respect to springiness, the results of FIG. 9 show that the cakes with up to 50% lower protein amount were comparable with the sponge cake containing the full dosage of BLG powder (variant 2). The full dosage BLG powder provided a significantly higher springiness than the reference containing eggs (variant 1).

The replacement of whole egg with BLG significantly increased the cake resilience (see FIG. 10). Cake variants 2-9 all provided a resilience higher than that of the egg-containing reference cake (variant 1).

Conclusion:

Cakes containing the BLG powder performed significantly better that than of the whole egg-containing reference. The replacement of whole egg with BLG powder increased the cake volume, the springiness and the resilience. The hardness of the cake can be adjusted by adjusting the dosage of the BLG powder.

1. A method of preparing an aerated batter, the method comprising:
a. Providing a protein source comprising beta-lactoglobulin (BLG), wherein BLG constitutes at least 85% of the protein of the protein source comprising BLG,
b. Providing one or more batter ingredients comprising at least one of: sugar, flour, and starch,
c. Mixing the one or more batter ingredients with the protein source comprising BLG to form a mixture, and
the method furthermore comprises at least one aeration step,
thereby providing the aerated batter.

2. The method according to claim 1, wherein the at least one aeration step involves aerating one or more of:
the protein source comprising BLG,
the one or more batter ingredients,
a premixture made during step c. comprising the protein source comprising BLG and/or the one or more batter ingredients, and
the mixture.

3. The method according to claim 1, wherein BLG constitutes at least 90% w/w of the protein of the protein source comprising BLG, more preferably at least 95% w/w, even more preferably at least 96% w/w, and most preferably at least 97% w/w.

4. The method according to claim 1, wherein the protein source comprising BLG has a degree of protein denaturation of at most 90%, more preferably at most 70%, even more preferably at most 50%, and most preferably at most 30%.

5. The method according to claim 1, wherein the protein source comprising BLG has a degree of protein denaturation of at most 10%, more preferably at most 8%, even more preferably at most 5%, and most preferably at most 2%.

6. The method according to claim 1 wherein the batter comprises at most 6.0 wt % non-dairy protein relative to the weight of the batter.

7. The method according to claim 1, wherein the ratio between dairy protein and non-dairy protein is in the range of 5:1 to 1:5.

8. The method according to claim 1, wherein the batter comprises in the range of 20-80% w/w sugar relative to the weight of the batter.

9. The method according to claim 1, wherein the batter comprises at most 1% w/w fat relative to the weight of the batter.

10. The method according to claim 1, wherein the batter has a fat content in the range of 5-35% w/w, such as in the range of 10-30% w/w, in the range of 15-30% w/w or in the range of 20-30% w/w.

11. The method according to claim 1, wherein the protein source comprising BLG contributes with at least 40% w/w of the total amount of protein of the batter, more preferably at least 50% w/w, even more preferably at least 60% w/w, and most preferably at least 70% w/w.

12. The method according to claim 1, wherein the protein source comprising BLG contributes with 40-95% w/w of the total amount of protein of the batter, more preferably 45-90% w/w, even more preferably 50-80% w/w, and most preferably 55-75% w/w.

13. The method claim 1, wherein the ratio between BLG and ovalbumin of the aerated batter is from 1:1 to 10:1.

14. The method according to claim 1, wherein the aerated batter comprises or even consists of the following batter ingredients in the specified amounts:
protein source comprising BLG: sufficient to provide BLG in an amount of about 1-6% w/w,
flour: between about 15% and about 60% w/w,
sugar: between about 20% and about 50% w/w,
starch: between about 0% and about 30% w/w,
leavening agent: between about 1% and about 4% w/w,
emulsifier: between about 1% and about 4% w/w,
optionally flavour, colour and preservative,
liquid, preferably water: to reach 100%.

15. The method according to claim 1, wherein the aerated batter comprises or even consists of the following batter ingredients in the specified amounts:
protein source comprising BLG: sufficient to provide BLG in an amount of about 1.5-5% w/w,
flour: between about 15% and about 40% w/w,
sugar: between about 20% and about 30% w/w,
starch: between about 10% and about 20% w/w,
leavening agent: between about 1% and about 2% w/w,
emulsifier: between about 2% and about 3% w/w,
optionally flavour, colour and preservative,
liquid, preferably water: to reach 100%.

16. The method according to claim 1, wherein the aerated batter comprises or even consists of the following batter ingredients in the specified amounts:
flour: between about 10% and about 20% w/w,
sucrose: between about 20% and about 50% w/w,
sugar, icing: between about 20% and about 50% w/w,
salt: between about 0.5% and about 1% w/w,
tartaric acid: between about 0.05% and about 0.5% w/w,
optionally flavour, colour and preservative,
water: to reach 100%.

17. The method according to claim 1, wherein the aerated batter comprises or even consists of the following batter ingredients in the specified amounts:
protein source comprising BLG: sufficient to provide BLG in an amount of about 2-8% w/w,
flour: between about 15% and about 60% w/w,
sugar: between about 20% and about 50% w/w,
starch: between about 0% and about 20% w/w,
vegetable oil: between about 10% and about 35% w/w,
emulsifier: between about 0.5% and about 2% w/w,
optionally flavour, colour and preservative,
water: to reach 100%.

18. The method according to claim 1, wherein the aerated batter comprises or even consists of the following batter ingredients in the specified amounts:
protein source comprising BLG: sufficient to provide BLG in an amount of about 3-6% w/w,
flour: between about 15% and about 40% w/w,
sugar: between about 20% and about 35% w/w,
starch: between about 0% and about 15% w/w,
vegetable oil: between about 10% and about 20% w/w,
emulsifier: between about 0.5% and about 2% w/w,
optionally flavour, colour and preservative,
water: to reach 100%.

19. The method according to claim 1, wherein the aerated batter comprises or even consists of the following batter ingredients in the specified amounts:
protein source comprising BLG: sufficient to provide BLG in an amount of about 1-6% w/w,
sugar: between about 50% and about 80% w/w,
optionally flavour, colour and preservative,
water: to reach 100%.

20. An aerated batter produced by the method of claim 1.

21. A cake produced by baking the aerated batter according to claim 20.

22. (canceled)

23. A powder composition suitable for making an aerated batter, which powder composition comprises one or more batter ingredients and a protein source comprising BLG, wherein the BLG constitutes at least 85% of the protein of the protein source, and where the one or more batter ingredients are dry and comprises at least one of sugar, flour and starch.
